(19) United States
(12) Patent Application Publication
(10) Pub. No.: US 2004/0259591 A1
(43) Pub. Date: Dec. 23, 2004

(54) Gesture-based interface and method for wireless device

(75) Inventors: Richard E. Grams, Chandler, AZ (US); Ryan M. Brinkerhoff, Mesa, AZ (US); John E. Clayton JR., Scottsdale, AZ (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC.

(21) Appl. No.: 10/463,812

(22) Filed: Jun. 17, 2003

(51) Int. Cl. H04M 1/00; H04B 1/38

(52) U.S. Cl. 455/556.1; 455/557

(57) ABSTRACT

A system, method and computer program product for providing a gesture-based interface on a wireless device (102). The method on a wireless device (102) includes detecting a movement from a user by a motion detector and accelerometer (104) that is integrally located in the wireless device (102) or located externally to the wireless device (102) and coupled to the wireless device (102). The method further includes providing user input to a user interface of the wireless device (102) in response to the detecting the movement. The user input includes navigating selections in the user interface of the wireless device (102), such as moving between pages displaying a list of selections and scrolling through a list of selections. The user input further includes activating selections in the user interface of the wireless device (102), such as initiating or answering a wireless telephone call and sending or receiving a wireless message.

### FIELD OF THE INVENTION

The present invention generally relates to the field of gesture-based interfaces, and more particularly relates to gesture-based interfaces for wireless devices.

### BACKGROUND OF THE INVENTION

With the advent of pagers and mobile telephones, the wireless service industry has grown into a multi-billion dollar industry. The Cellular Telecommunications and Internet Association calculates that 120 million Americans own a mobile telephone —about half of the U.S. population. As the development and availability of mobile telephones progresses the benefits of mobile telephones are reaching more and more people. The benefits of mobile telephones, however, are not available to thousands of handicapped individuals that are currently confined to wheelchairs. Often, people with higher level spinal injuries or disease (such as quadriplegics, paraplegics, hemiplegics, etc.) that are confined to wheelchairs have some arm movement, but not enough finger control to operate normal mobile telephone buttons. These individuals are essentially helpless when put to bed at night and again they can not make use of a normal mobile telephone.

Furthermore, these handicapped individuals face unique obstacles with regards to trips away from home. In one example, inadvertently running an electric wheelchair too long or too hard can lead to an unexpected failure of battery power, leaving the wheelchair user stranded. In another example, the user's wheelchair can be accidentally tipped over due to a street or sidewalk curb. If the wheelchair user is unable to place the wheelchair in an upright position and re-seat himself, this event would also leave the wheelchair user stranded. These obstacles are compounded by other impediments, such as railroad tracks and frequent street crossings. Currently, there is a lack of communications and automatic features like emergency dialing for these wheelchair users.

Therefore a need exists to overcome the problems with the prior art as discussed above.

### SUMMARY OF THE INVENTION

Briefly, in accordance with the present invention, disclosed is a system, method and computer program product for providing a gesture-based interface on a wireless device. The method on a wireless device includes detecting a movement from a user by an accelerometer that is integrally located in the wireless device or located externally to the wireless device and coupled to the wireless device. The accelerometer may detect movement occurring along any of two or three axes. The method further includes providing user input to a user interface of the wireless device in response to the detecting the movement. The user input includes navigating selections in the user interface of the wireless device, such as moving between pages displaying a list of selections and scrolling through a list of selections. The user input further includes activating selections in the user interface of the wireless device, such as initiating or answering a wireless telephone call and sending or receiving a wireless message.

In another embodiment of the present invention, a movement-based interface system is disclosed. The system includes a wireless device comprising a user interface and a motion detector for detecting motion of the wireless device imparted by a user. The system further includes a signal generator coupled to the motion detector for sending a signal to a processor when motion is detected by the motion detector. The system further includes a processor in the wireless device for receiving the signal from the signal generator, processing the signal and, providing user input to the user interface of the wireless device

In yet another embodiment of the present invention, a computer program product for providing a gesture-based interface on a wireless device is disclosed. The computer program product includes instructions for detecting a movement from a user by an accelerometer that is integrally located in the wireless device or located externally to the wireless device and coupled to the wireless device. The accelerometer may detect movement occurring along any of two or three axes. The computer program product further includes instructions for providing user input to a user interface of the wireless device in response to the detecting the movement. The user input includes navigating selections in the user interface of the wireless device, such as moving between pages displaying a list of selections and scrolling through a list of selections. The user input further includes activating selections in the user interface of the wireless device, such as initiating or answering a wireless telephone call and sending or receiving a wireless message.

### BRIEF DESCRIPTION OF THE DRAWINGS

FIG. 1 is a block diagram illustrating a gesture-based interface system, according to one embodiment of the present invention.

FIG. 2 is a more detailed illustration of a back view of the wireless device holder of FIG. 1.

FIG. 3 is a more detailed illustration of a front view of the wireless device holder of FIG. 1.

FIG. 4 is an illustration of the gesture-based interface system of FIG. 1, implemented in an exemplary wheelchair.

FIG. 5 is an illustration of the gesture-based interface system of FIG. 1, implemented in an exemplary hospital bed.

FIG. 6 is an illustration of the motion detector in relation to the wireless device, according to one embodiment of the present invention.

FIG. 7 is a more detailed block diagram of a wireless device including a motion detector, according to one embodiment of the present invention.

FIG. 8 is an illustration of detection of motion by the motion detector, according to one embodiment of the present invention.

FIG. 9 is an illustration of detection of motion in one axis by the motion detector, according to one embodiment of the present invention.

FIG. 10 is an illustration of detection of motion in a second axis by the motion detector, according to one embodiment of the present invention.

FIG. 11 is an illustration of detection of tilt by the motion detector, according to one embodiment of the present invention.

FIG. 12 is an illustration of a menu interface in the wireless device of FIG. 1.

FIG. 13 is an illustration of another menu interface in the wireless device of FIG. 1.

FIG. 14 is an operational flow diagram showing an exemplary process of the gesture-based interface system of FIG. 1, according to one embodiment of the present invention.

FIG. 15 is a block diagram of a computer system useful for implementing an embodiment of the present invention.

FIG. 16 is an illustration of one implementation of a gesture-based interface, according to one embodiment of the present invention.

### DETAILED DESCRIPTION

The present invention, according to a preferred embodiment, overcomes problems with the prior art by allowing users to enter information into an interface of a wireless device using simple gestures.

FIG. 1 is a block diagram illustrating a gesture-based interface system, according to one embodiment of the present invention. FIG. 1 shows a wireless device 102 including a motion detector 104. FIG. 1 also shows the wireless device 102 coupled to a device holder 106, which is further coupled to an exemplary wheelchair 108. The wireless device 102 is a desktop computer, laptop computers handheld computer, palmtop computer, mobile phone, push-to-talk mobile radio, text messaging device, two way pager, one way pager, or the like. The wireless device 102 is equipped with a transmitter and receiver for communicating with a wireless network according to the appropriate wireless communication standard. The wireless device 102 is described in greater detail with reference to FIG. 7 below.

The wireless network to which wireless device 102 connects is a first-generation analog mobile phone service (1G), a second-generation (2G) digital mobile phone service, a third-generation (3G) Internet-capable mobile phone service or a fourth generation (4G) phone service. Further, the communications standard of the wireless network is Code Division Multiple Access (CDMA), Time Division Multiple Access (TDMA), Global System for Mobile Communications (GSM), General Packet Radio Service (GPRS), Frequency Division Multiple Access (FDMA) or the like.

FIG. 1 also shows a motion detector 104, which is, in one example, a Micro-Electro-Mechanical System (MEMS) accelerometer for measuring dynamic acceleration and static acceleration. The FIG. 1 shows that the motion detector 104 can be located in two alternative locations. A first alternative location for the motion detector 104 is within wireless device 102. In this alternative, the motion detector 104 is integrally fabricated with the wireless device 102.

A second alternative location for the motion detector 104 is external to wireless device 102, but coupled to wireless device 102. In this alternative, the motion detector 104 is fabricated apart from the wireless device 102 but is connected to the wireless device 102 using a cord or wire, or is connected wirelessly to the wireless device 102 using RF communication. The motion detector 104 can be fabricated as a joystick, mouse, roll-ball, or any other device for data input. The motion detector 104 is described in greater detail with reference to FIGS. 6-8 and FIG. 16 below.

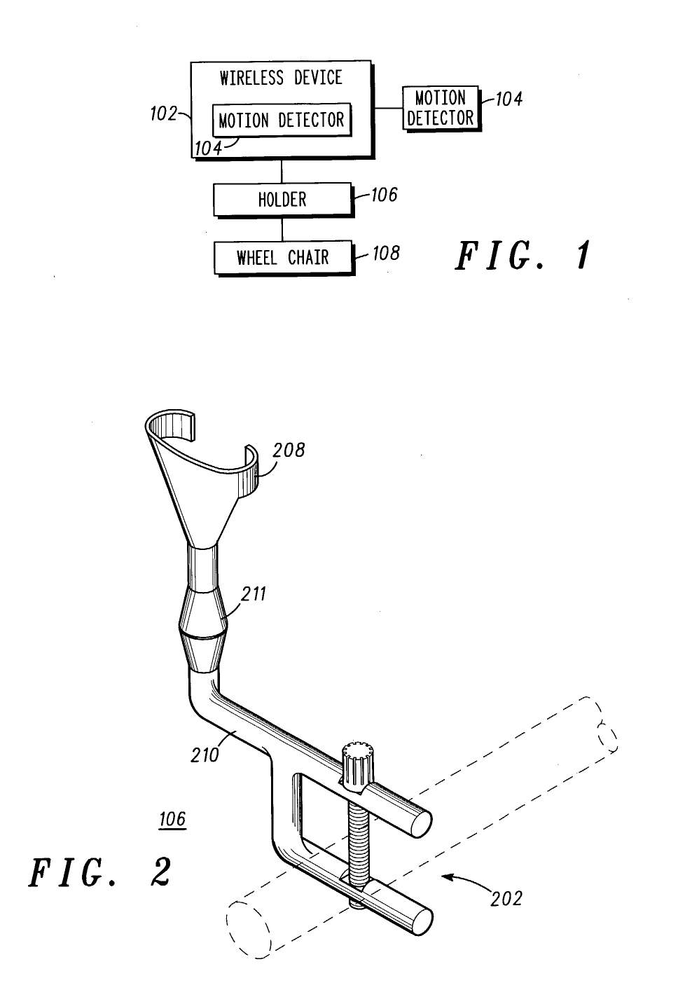

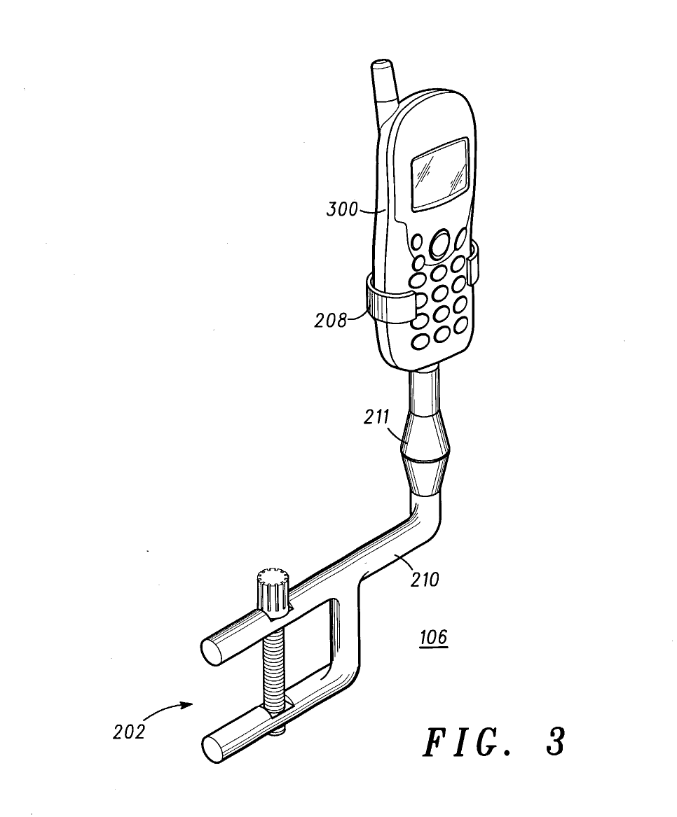

FIG. 1 further shows a device holder or holster 106 for holding the wireless device 102. The holder 106 serves to hold the wireless device 102 and to attach itself to another object, such as a wheelchair 108, a hospital bed, a car accessory such as a dashboard, or the like. The holder 106 holds or supports the wireless device 102 in a predetermined position, such as an upright position. Further, the holder 106 is equipped with a mechanism for coupling to an object such as the armrest of a wheelchair 108, the side-rail of a hospital bed or the dashboard of a car. The holder 106 allows the user, such as a handicap person, to have the wireless device 102 available in an upright position ready for use. The holder 106 is described in greater detail with reference to FIGS. 2 and 3 below.

FIG. 16 is an illustration of one implementation of a gesture-based interface 1600, according to one embodiment of the present invention. FIG. 16 shows a gesture-based interface 1600 including a motion detector 102, the gesture-based interface 1600 being manufactured separately from the wireless device 102, such as is shown in the upper right hand area of FIG. 1. The gesture-based interface 1600 includes a joystick or stub 1602 coupled to a base 1604. The joystick 1602 includes a joint 1603 at its base that allows the joystick 1602 to be moved in any direction about the joint 1603.

FIG. 16 also shows a motion detector 104 positioned in the tip of the joystick 1602. The motion detector 104 is, in one example, a MEMS accelerometer for measuring dynamic acceleration and static acceleration. A MEMS accelerometer can also be used as an inclinometer to measure incline when the motion detector 104 is positioned in a particular orientation. Thus, a user can interact with the joystick 1602 in order to issue commands to wireless device 102. Using the motion detector 104 located in the tip of the joystick 1602, gestures of a user can be detected and transmitted to the wireless device 102. The method in which gestures and detected is described in greater detail below.

As noted above, the joystick 1602 is fabricated apart from the wireless device 102 but is connected to the wireless device 102 using a cord or wire, or is connected wirelessly to the wireless device 102 using RF communication.

FIG. 2 is a more detailed illustration of a back view of the wireless device holder 106 of FIG. 1. FIG. 2 shows one embodiment of a holder 106, as shown in FIG. 1. The holder 106 comprises a support element 208 for holding or supporting a wireless device 102, such as a mobile telephone. The support element 208 can be a sleeve, a clasp, a clip or any other mechanism that is equipped to hold the wireless device 102 in a predetermined position, such as in an upright position.

The holder 106 further comprises a coupling mechanism 202 for coupling the holder 106 to another object, such as the armrest of a wheelchair 108, the side-rail of a hospital bed or the dashboard of a car. The coupling mechanism 202 can be a sleeve, a clasp, a clip or any other mechanism that is equipped to couple the holder 106 to another object.

The holder 106 further comprises a shaft 210 for coupling the support element 208 to the coupling mechanism 202. Shaft 210 can be a rigid element, or a flexible element that allows for bending of the shaft 210. Optionally, the shaft 210 comprises a movable bearing element 211 that allows rotational movement of the support element 208 relative to the coupling mechanism 202. FIG. 2 shows that the shaft 210 is an angled element coupling the support element 208 to the coupling mechanism 202. This is because the support element 208 is designed to hold the wireless device 102 in an upright position and the coupling mechanism 202 is designed to clasp or couple to an object laterally, or from the side. In another embodiment, the shaft 210 is a straight rod-like element coupling the support element 208 to the coupling mechanism 202. This is because the support element 208 is designed to hold the wireless device 102 in an upright position and the coupling mechanism 202 is designed to clasp or couple to an object from above or from the top.

FIG. 3 is a more detailed illustration of a front view of the wireless device holder 106 of FIG. 1. FIG. 3 further shows that the holder 106 is holding or supporting a wireless device 300, depicted as a mobile telephone. FIG. 3 shows that the support element 208 is designed to hold the wireless device 300 in an upright position and the coupling mechanism 202 is designed to clasp or couple to an object laterally, or from the side. Optionally, the holder 106 includes a movable bearing element 211 that allows rotational movement of the support element 208 relative to the coupling mechanism 202.

FIG. 4 is an illustration of the gesture-based interface system of FIG. 1, implemented with an exemplary wheelchair 108. The holder 106 holds or supports the mobile telephone 300 in an upright position using a support element 208. Further, the holder 106 is equipped with a coupling mechanism 202 for coupling to an object such as the armrest 402 of the wheelchair 108. The holder 106 allows the user, such as a handicap person, to have the wireless device 300 available in an upright position and ready for use when the user is in a wheelchair. Optionally, the holder 106 includes a movable bearing element 211 that allows rotational movement of the support element 208 relative to the coupling mechanism 202.

In one embodiment of the present invention, the wireless device 300 may also be implemented using an external motion detector, such as described with respect to FIG. 16 above. In this embodiment, the joystick 1602 would be located closer to the user's hand or other moving appendage, such as on the seat of the wheelchair 108.

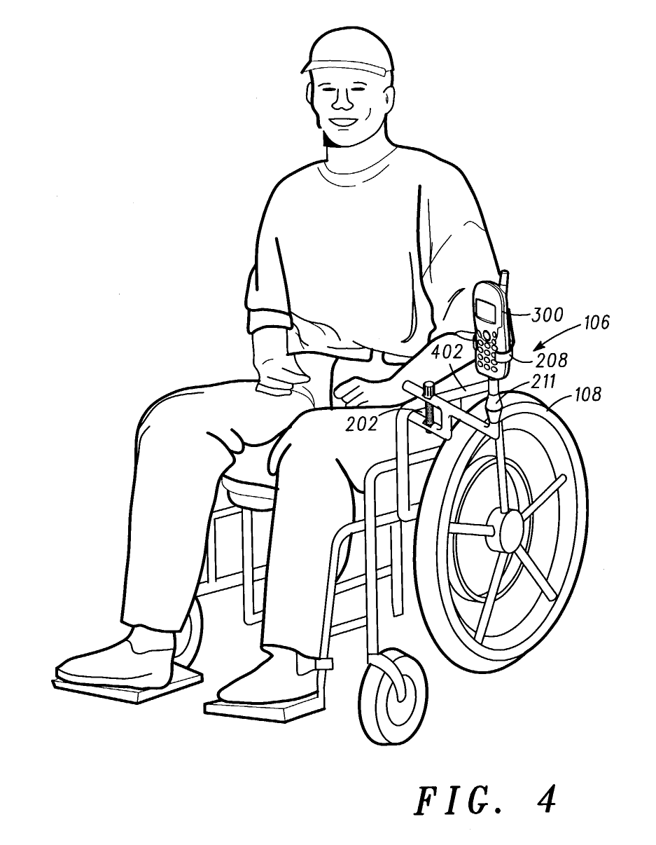

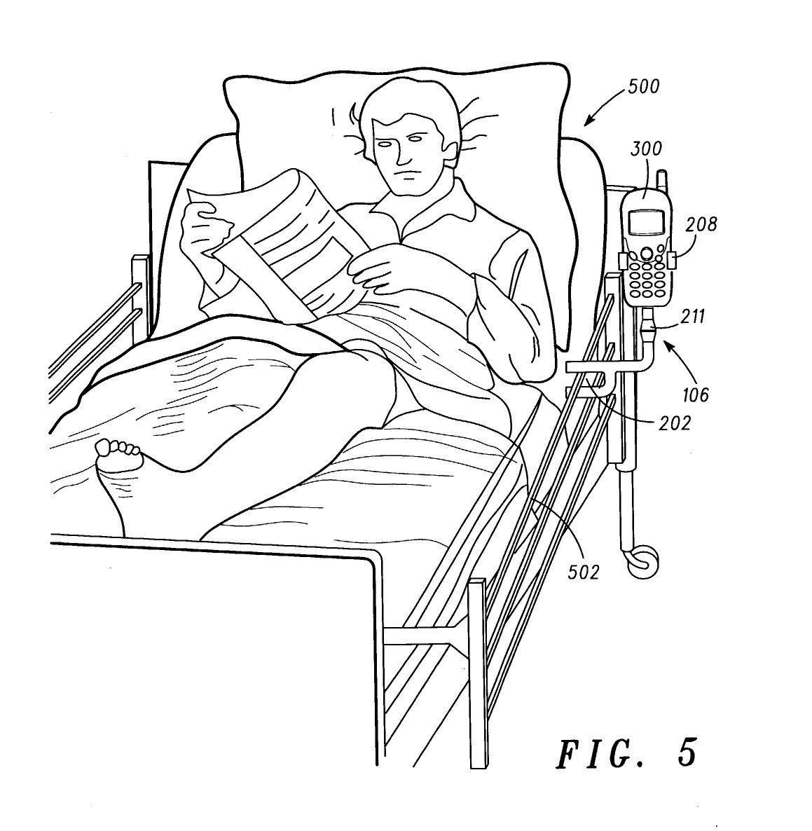

FIG. 5 is an illustration of the gesture-based interface system of FIG. 1, implemented in an exemplary hospital bed 500. The holder 106 holds or supports the mobile telephone 300 in an upright position using a support element 208. Further, the holder 106 is equipped with a coupling mechanism 202 for coupling to an object such as the side-rail 502 of a hospital bed 500. The holder 106 allows the user, such as a handicap person, to have the wireless device 300 available in an upright position and ready for use when the user is in a hospital bed. Optionally, the holder 106 includes a movable bearing element 211 that allows rotational movement of the support element 208 relative to the coupling mechanism 202.

In one embodiment of the present invention, the wireless device 300 may also be implemented using an external motion detector, such as described with reference to FIG. 16 above. In this embodiment, the joystick 1602 would be located closer to the user's hand or other moving appendage, such as on the bed 500.

FIG. 6 is an illustration of the motion detector 104 in relation to the mobile telephone 300 (i.e., wireless device 102), according to one embodiment of the present invention. In one embodiment, the motion detector 104 is a MEMS accelerometer for measuring dynamic acceleration and static acceleration, or gravity. As explained above, the motion detector 104 can be located in two alternative locations. A first alternative location for the motion detector 104 is within mobile telephone 300. In this alternative, the motion detector 104 is integrally fabricated with the mobile telephone 300.

A second alternative location for the motion detector 104 is external to mobile telephone 300, but coupled to mobile telephone 300. In this alternative, the motion detector 104 is fabricated apart from the wireless device 102, but connected to the mobile telephone 300 using an interface. The motion detector 104, for example, can be fabricated as a joystick, mouse, roll-ball, or any other device for data input. The MEMS accelerometer of the motion detector 104 can be located, for example, in the topmost tip of a joystick. The interface can be a serial peripheral interface, a serial communication interface, an RS-422 interface, an RS-232 interface, a wireless interface, or the like. The motion detector 104 is described in greater detail with reference to FIGS. 7-8 below.

FIG. 7 is a more detailed block diagram of a wireless device including a motion detector, according to one embodiment of the present invention. FIG. 7 shows a wireless device, such as wireless device 102 of FIG. 1. In one embodiment of the present invention, the wireless device 102 is a two-way radio capable of receiving and transmitting radio frequency signals over a communication channel under a communications protocol such as CDMA, FDMA, GPRS or GSM. The wireless device 102 operates under the control of a controller 702, which switches the wireless device 102 between receive and transmit modes. In receive mode, the controller 702 couples an antenna 720 through a transmit/receive switch 714 to a receiver 712. The receiver 712 decodes the received signals and provides those decoded signals to the controller 702. In transmit mode, the controller 702 couples the antenna 720, through the switch 714, to a transmitter 716.

The controller 702 operates the transmitter 716 and receiver 712 according to instructions stored in memory 708. These instructions, according to an exemplary embodiment where the wireless device 102 comprises a cellular telephone, include a neighbor cell measurement-scheduling algorithm. In preferred embodiments of the present invention, memory 708 comprises any one or any combination of non-volatile memory, Flash memory or Random Access Memory. A timer module 706 provides timing information to the controller 702 to keep track of timed events. Further, the controller 702, according to the present example, can utilize the time information from the timer module 706 to keep track of scheduling for neighbor cell server transmissions and transmitted color code information.

When a neighbor cell measurement is scheduled, the receiver 712, under the control of the controller 702, monitors neighbor cell servers and receives a “received signal quality indicator” (RSQI). RSQI circuit 718 generates RSQI signals representing the signal quality of the signals transmitted by each monitored cell server. Each RSQI signal is converted to digital information by an analog-to-digital converter 710 and provided as input to the controller 702. Using the color code information and the associated received signal quality indicator, the wireless device 702 determines the most appropriate neighbor cell server to use as a primary cell server when hand-off is necessary.

Processor 704 in FIG. 7 performs various functions such as the functions attributed to the motion detection process, as described below with reference to FIG. 14. In various embodiments of the present invention, the processor 704 in FIG. 7 comprises a single processor or more than one processor for performing the tasks described below.

FIG. 7 also includes a motion detector 104. As explained above, the motion detector 104 can be located in two alternative locations. The first alternative location is within mobile telephone 300, in which case the motion detector 104 is integrally fabricated with the mobile telephone 300. The second alternative location is external to mobile telephone 300, but coupled to mobile telephone 300 using an interface such as a serial peripheral interface, a serial communication interface, an RS-422 interface, an RS-232 interface, a wireless interface, or the like. The motion detector 104, for example, can be fabricated as a joystick, mouse, roll-ball, or any other device for data input. The motion detector 104 is described in greater detail with reference to FIG. 8 below.

FIG. 8 is an illustration of detection of motion by the motion detector 104, according to one embodiment of the present invention. FIG. 8 shows the hand 800 of a user and a top view of the mobile telephone 300. In the example of FIG. 8, a user utilizes his or her hand to move the mobile telephone 300 in order to input information into an interface. This process is described in greater detail below.

FIG. 8 assumes that the motion detector 104 is located within, and integrally formed with, the wireless device 102, i.e., the mobile telephone 300. In one embodiment, the motion detector 104 is a MEMS accelerometer for measuring dynamic acceleration and static acceleration. The MEMS accelerometer can measure dynamic acceleration along one, two or three axes. FIG. 8 also assumes a motion detector 104 comprising a MEMS accelerometer for measuring dynamic acceleration along two or three axes.

FIG. 8 also shows two axes: a first axis 810 in the forward-backward direction, and a second axis 820 in the left-right direction. Not shown is a third axis in the up-down direction. The two axes 810 and 820 are axes along which the MEMS accelerometer of the motion detector 104 measures dynamic acceleration.

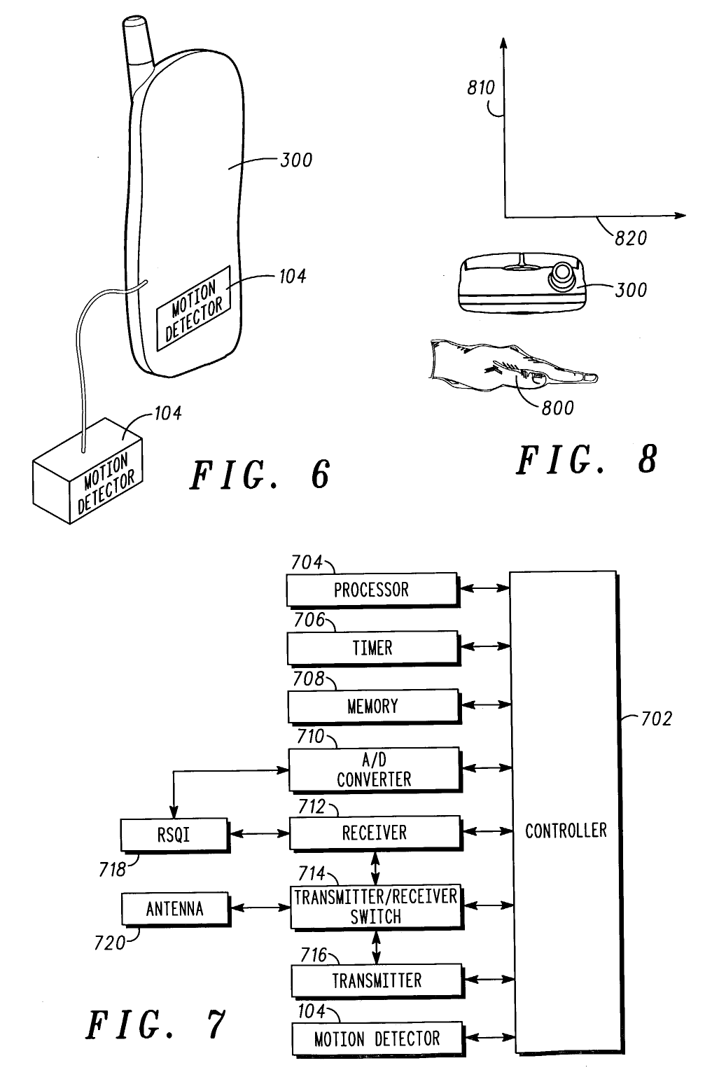

FIG. 9 is an illustration of detection of motion along the first axis 810 by the motion detector 104, according to one embodiment of the present invention. As explained above, the motion detector 104 comprises a MEMS accelerometer for measuring dynamic acceleration along two axes: 810 and 820. In FIG. 9, the user pushes the mobile telephone 300 in the forward-backward direction, i.e., along the 810 axis. This movement is detected by the MEMS accelerometer of the motion detector 104. In response, information is input into an interface of the mobile telephone 300. This process is described in greater detail below with reference to FIGS. 12-14.

FIG. 10 is an illustration of detection of motion in a second axis 820 by the motion detector 104, according to one embodiment of the present invention. As explained above, the motion detector 104 comprises a MEMS accelerometer for measuring dynamic acceleration along two axes: 810 and 820. In FIG. 10, the user pushes the mobile telephone 300 in the left-right direction, i.e., along the 820 axis. This movement is detected by the MEMS accelerometer of the motion detector 104. In response, information is input into an interface of the mobile telephone 300. This process is described in greater detail below with reference to FIGS. 12-14.

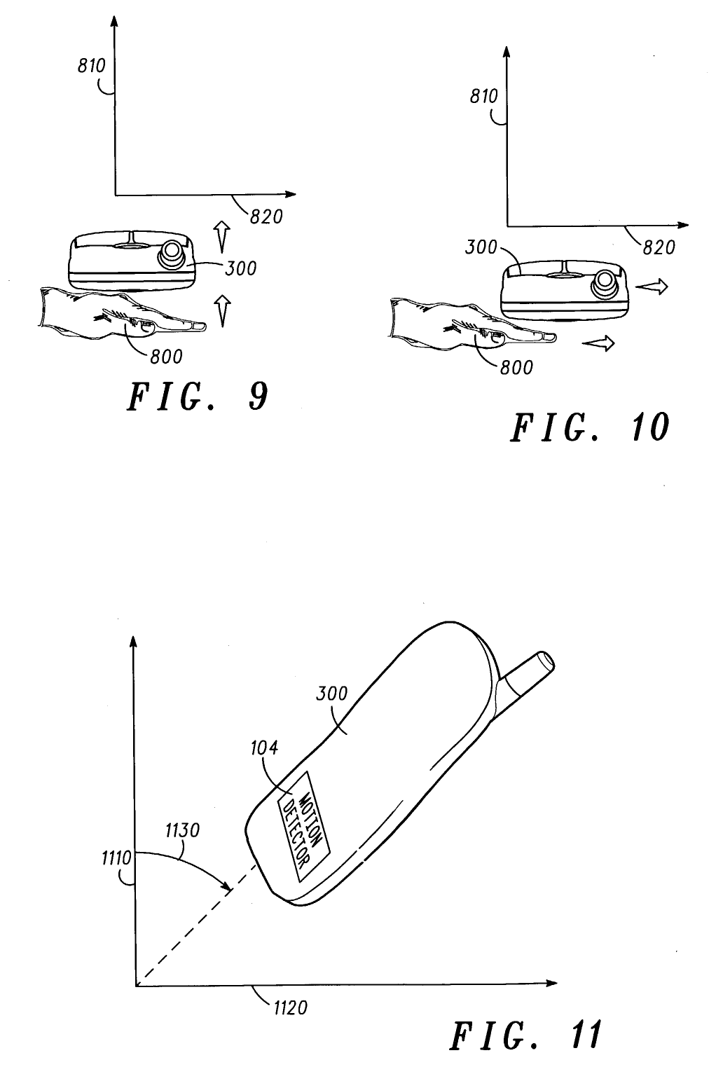

FIG. 11 is an illustration of detection of tilt by the motion detector 104, according to one embodiment of the present invention. FIG. 11 shows a frontal view of the mobile telephone 300. In the example of FIG. 11, a user utilizes his or her hand to move the mobile telephone 300 in order to input information into an interface. This process is described in greater detail below.

FIG. 11 assumes that the motion detector 104 is located within, and integrally formed with, the wireless device 102, i.e., the mobile telephone 300. In one embodiment, the motion detector 104 is a MEMS accelerometer for measuring dynamic acceleration and static acceleration. The MEMS accelerometer can measure static acceleration by measuring the extent that the mobile telephone 300 is tilted in any axis. FIG. 11 shows that the mobile telephone 300 is tilted at an angle 1130 from the vertical 1110. Conversely, the mobile telephone 300 is tilted at an angle from the horizontal 1120, the angle being ninety degrees minus the angle 1130. This movement is detected by the MEMS accelerometer of the motion detector 104. In response, information is input into an interface of the mobile telephone 300. This process is described in greater detail below with reference to FIGS. 12-14.

Note that FIGS. 8-11 assume that the motion detector 104 is located within the wireless device 102. Recall that the motion detector 104 can be fabricated as a joystick, mouse, roll-ball, or any other device for data input. In an embodiment where the motion detector 104 is fabricated, apart from the wireless device 102, the user would move the motion detector 104 in order to input data. For example, the user would move the joystick, mouse, or roll-ball. This movement is detected by the MEMS accelerometer of the motion detector 104. In response, information is input into an interface of the mobile telephone 300. This process is described in greater detail below with reference to FIGS. 12-14.

As explained above, MEMS accelerometer of the motion detector 104 of the wireless device 102 can measure dynamic acceleration and static acceleration. Thus, movement along one, two or three axes and tilt can be detected by the motion detector 104 of the wireless device 102. In this way, the user utilizes his hand 800 or any other body part or extension of a body part to move the wireless device 102 or motion detector 104 in order to input data into an interface of the wireless device 102. In addition to movement along an axis and tilt, the system of the present invention can measure the speed of a movement. This can be accomplished simply by measuring the time between positions of the motion detector 104. The addition of speed measurement adds another aspect to gesture interpretation.

As such, the system of the present invention can detect a variety of gestures. A non-exhaustive list of gestures that can be detected by the present invention are presented below:

a slow movement along an axis to a new position

a quick movement along an axis to a new position

a slow movement along an axis to a new position and a slow movement along an axis back to the original position,

a quick movement along an axis to a new position and a quick movement along an axis back to the original position

a slow movement along an axis to a new position and remaining at the new position for a period of time

a quick movement along an axis to a new position and remaining at the new position for a period of time

any combination of the gestures above

As explained above, gestures are performed by the user in order to input data into an interface of the wireless device 102. Thus, gestures described in the list above are mapped to a list of actions that are to be taken by the wireless device 102. The mapping function is performed by the motion detector 104, a component of the motion detector 104, the processor 704 of the wireless device 102, a component of the wireless device 102 or any combination of the above. Actions are descried in greater detail below.

Recall that input data can represent any action that the user desires the wireless device 102 to take. For example, input data can represent navigational commands, such as:

scroll (slow or fast) to the next item

scroll (slow or fast) to the previous item

paginate to the next page

paginate to the previous page

go to the next screen

go back to the previous screen

slide a slider (slow or fast) in a first direction

slide a slider (slow or fast) in a second direction opposite the first direction

In another example, input data can represent commands associated with the type of wireless device 102 being used or an application running or executing on the wireless device 102. For example, the input data can represent commands used on a typical mobile telephone 300, such as:

enter a number for dialing a telephone number

initiate a telephone call to the telephone number dialed

initiate a telephone call to a speed dial telephone number

initiate a telephone call to a telephone number in a phone book

enter a telephone number into speed dial or a phone book

recall or edit a number in speed dial or a phone book

answer an incoming telephone call

decline to answer an incoming telephone call

drop the current telephone call

In another example, the input data can represent commands associated with an application running or executing on the wireless device 102. For example, if an email application is executing on the wireless device 102, the input data can represent commands, such as:

display an incoming email message for viewing

delete an incoming email message

place an incoming email message in a particular folder replay to an incoming email message

enter a character as text in an outgoing email message

send an outgoing email message

FIG. 12 is an illustration of a menu interface 1200 in the wireless device 102 of FIG. 1. FIG. 12 shows an example of entering data into an interface of wireless device 102 for the purpose of performing an action or executing a process. FIG. 12 shows an interface 1200 in a display of a mobile telephone 300. The interface 1200 shows a Call Menu list of selections. The Call Menu is a menu that is presented to a user when the user desires to initiate a telephone call. The Call Menu includes three selections: a Speed Dial Call selection 1202 for making a speed dial telephone call, a Select from Phone Book selection 1204 for selecting a stored telephone number from a phone book and an Enter Number selection 1206 for entering a telephone number manually. FIG. 12 shows that Speed Dial Call selection 1202 is currently selected.

In the example of FIG. 12, the motion detector 104 is integrally formed in the mobile telephone 300. Also in this example, the system of the present invention recognizes two gestures: forward-backward movement of the mobile telephone 300 along the axis 810 (as shown in FIG. 9) and left-right movement of the mobile telephone 300 along the axis 820 (as shown in FIG. 10). In this example, a forward movement is mapped to scrolling upwards, a backwards movement is mapped to scrolling downwards, a left movement is mapped to going back to the previous screen and a right movement is mapped to going to the next screen. The user selects the Speed Dial Call selection 1202 by making a forward movement of the mobile telephone 300 (which is mapped to scrolling upwards). Subsequently, the user activates the Speed Dial Call selection 1202 by making a right movement of the mobile telephone 300 (which is mapped to going to the next screen). As a result, the user is presented with interface 1300, described below.

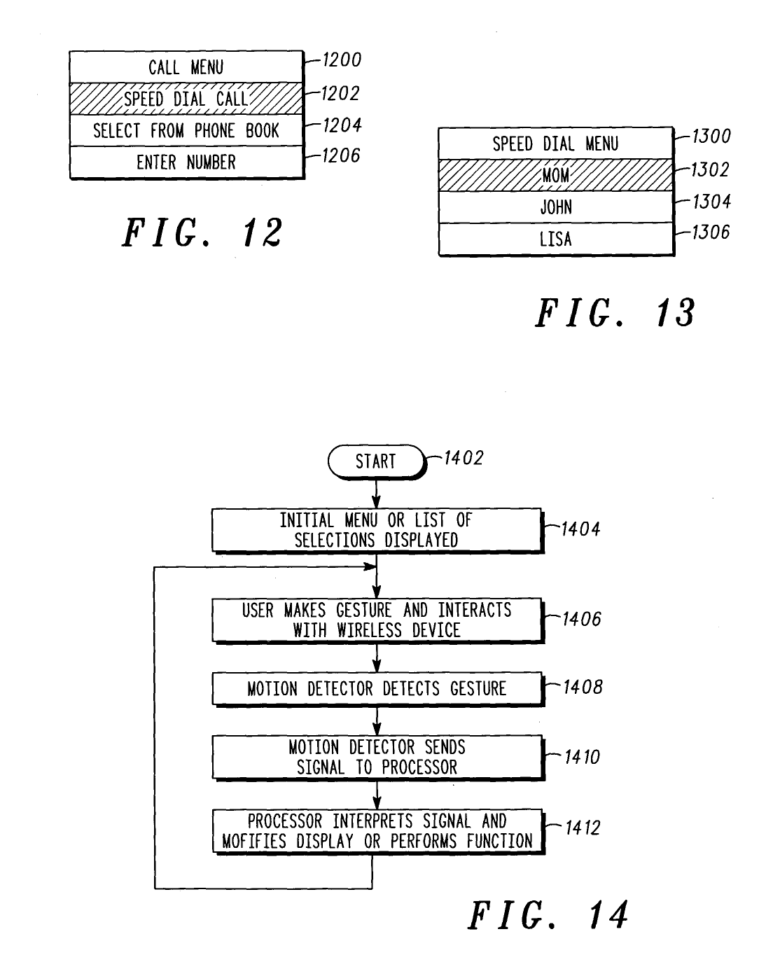

FIG. 13 is an illustration of another menu interface 1300 in the wireless device 102 of FIG. 1. FIG. 13 shows an example of entering data into an interface of wireless device 102 for the purpose of performing an action or executing a process. FIG. 13 shows an interface 1300 in a display of a mobile telephone 300. The interface 1300 shows a Speed Dial Menu list of selections. The Speed Dial Menu is a menu that is presented to a user when the user desires to initiate a telephone call using a speed dial feature. The Speed Dial Menu includes three selections: a Mom selection 1302 for making a speed dial telephone call to the user's mother, a John selection 1304 for making a speed dial telephone call to the user's friend John and a Lisa selection 1306 for making a speed dial telephone call to the user's friend Lisa.

The user selects the Mom selection 1302 by making a forward movement of the mobile telephone 300 (which is mapped to scrolling upwards). Subsequently, the user activates the Mom selection 1302 by making a right movement of the mobi001e telephone 300 (which is mapped to going to the next screen). As a result, the mobile telephone 300 initiates a telephone call to the user's mother.

FIG. 14 is an operational flow diagram showing an exemplary process of the gesture-based interface system of FIG. 1, according to one embodiment of the present invention. The operational flow diagram of FIG. 14 shows an overall process of how gestures from a user are interpreted by the gesture-based interface system of FIG. 1 in order to input data into an interface of the wireless device 102. The operational flow diagram of FIG. 14 begins with step 1402 and flows directly to step 1404.

In step 1404, an initial menu or list of selections are displayed for the user, such as shown in interfaces 1200 and 1300. Then, in step 1406, the user makes a gesture motion that interacts with the wireless device 102. The gesture of the user moves the wireless device 102 or the motion detector 104 of the wireless device 102, as shown in FIGS. 9-11. Subsequently, in step 1408, the motion detector 104 of the wireless device 102 detects the gesture of the user.

In step 1410, the motion detector 104 transmits a signal to the wireless device 102 with regards to the motion detected in step 1408. In one embodiment, the signal transmitted to the wireless device 102 contains movement data with regards to the motion detected in step 1408. In another embodiment of the present invention, the motion detector 104 maps the movement data to an action and the signal transmitted to the wireless device 102 contains action data with regards to the motion detected in step 1408.

In step 1412, the processor of the wireless device 102 interprets the signal received from the motion detector 104. In the embodiment where the signal transmitted to the wireless device 102 contains movement data with regards to the motion detected in step 1408, the processor of wireless device 102 maps the movement data to an action. In the embodiment where the signal transmitted to the wireless device 102 contains action data with regards to the motion detected in step 1408, the processor of wireless device 102 simply implements the action received. Subsequently, the action associated with the signal received is carried out. Then, control flows back to step 1406, where the process of interpreting gestures begins anew.

In one embodiment of the present invention, a wheelchair tip-over alarm is implemented. In this embodiment, the wireless device 102 is coupled to a wheelchair 108 via a device holder 106, as shown in FIG. 4. If the wheelchair 108 were to tip or fall over on its side, the user of the wheelchair 108 may not be able to stand the wheelchair 108 upright and re-position himself, and thus can become stranded. This is a health hazard for the user of a wheelchair 108 who cannot stand the wheelchair 108 upright and re-position himself.

In this embodiment, the MEMS accelerometer of the motion detector 104 of the wireless device 108 detects the tilt of the motion detector 104, as shown in FIG. 11. After a specified period of time, the wireless device 102 is programmed to notify another party that the wheelchair 108 has tipped over. This can be accomplished by automatically initiating a telephone call to an authority, such as a hospital or the police, a caregiver or other friend or family of the user of the wheelchair 108. Alternatively, this can be accomplished by automatically initiating a telephone call to any telephone number in a list of telephone numbers to notify other parties that the wheelchair 108 has tipped over. Optionally, the wireless device 102 may provide an override prompt to the user of the wheelchair 108, in case the user desires to override the initiation of the telephone call.

The present invention can be realized in hardware, software, or a combination of hardware and software on the wireless device 102, the motion detector 104 or any combination of the two. A system according to a preferred embodiment of the present invention can be realized in a centralized fashion in one information processing system, or in a distributed fashion where different elements are spread across several interconnected systems. Any kind of information processing system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product that includes all the features enabling the implementation of the methods described herein, and which, when loaded in a system, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A system may include, inter alia, one or more information processing systems and/or computers and at least a machine-readable or computer-readable medium, allowing a system, to read data, instructions, messages or message packets, and other information from the machine-readable or computer-readable medium. The machine-readable or computer-readable medium may include non-volatile memory, such as ROM, Flash memory, Disk drive memory, CD-ROM, and other permanent storage. Additionally, a machine-readable or computer-readable medium may include, for example, volatile storage such as RAM, buffers, cache memory, and network circuits. Furthermore, the machine-readable or computer-readable medium may include information in a transitory state medium such as a network link and/or a network interface, including a wired network or a wireless network, that allow a computer system to read such computer-readable information.

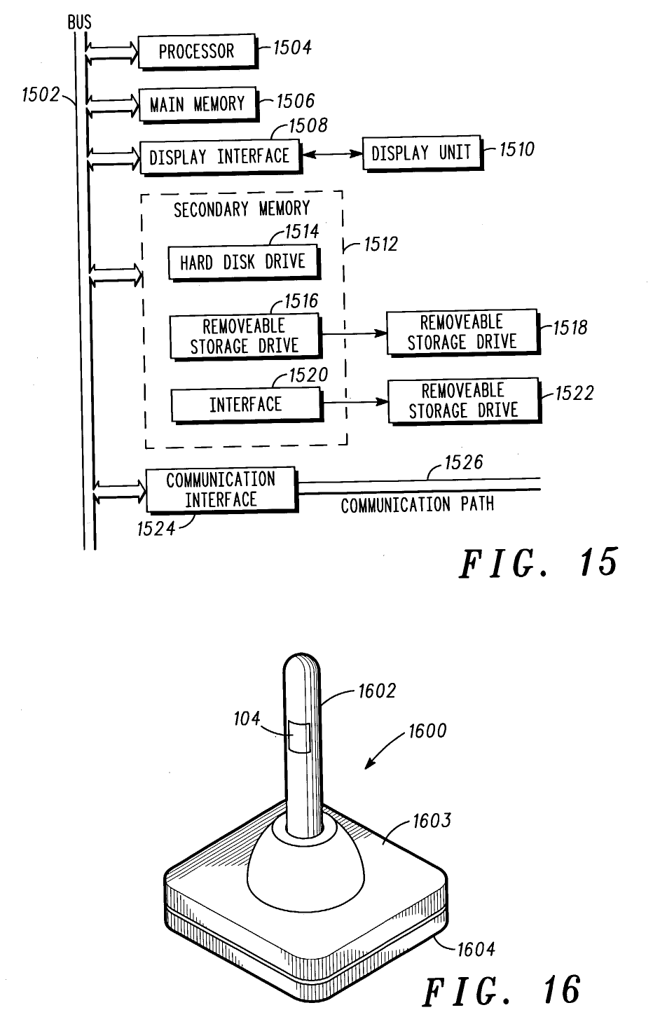

FIG. 15 is a block diagram of a computer system useful for implementing an embodiment of the present invention. The computer system of FIG. 15 includes multiple processors, such as processors 1504. The processors 1504 are connected to a communication infrastructure 1502 (e.g., a communications bus, cross-over bar, or network). At least one cache is also connected to the communication infrastructure 1502. Various software embodiments are described in terms of this exemplary computer system. After reading this description, it will become apparent to a person of ordinary skill in the relevant art(s) how to implement the invention using other computer systems and/or computer architectures.

The computer system can include a display interface 1508 that forwards graphics, text, and other data from the communication infrastructure 1502 (or from a frame buffer not shown) for display on the display unit 1510. The computer system also includes a main memory 1506, preferably random access memory (RAM), and may also include a secondary memory 1512. The secondary memory 1512 may include, for example, a hard disk drive 1514 and/or a removable storage drive 1516, representing a floppy disk drive, a magnetic tape drive, an optical disk drive, etc. The removable storage drive 1516 reads from and/or writes to a removable storage unit 1518 in a manner well known to those having ordinary skill in the art. Removable storage unit 1518, represents a floppy disk, magnetic tape, optical disk, etc., which is read by and written to by removable storage drive 1516. As will be appreciated, the removable storage unit 1518 includes a computer usable storage medium having stored therein computer software and/or data.

In alternative embodiments, the secondary memory 1512 may include other similar means for allowing computer programs or other instructions to be loaded into the computer system. Such means may include, for example, a removable storage unit 1522 and an interface 1520. Examples of such may include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to the computer system.

The computer system may also include a communications interface 1524. Communications interface 1524 allows software and data to be transferred between the computer system and external devices. Examples of communications interface 1524 may include a modem, a network interface (such as an Ethernet card), a communications port, a PCMCIA slot and card, etc. Software and data transferred via communications interface 1524 are in the form of signals which may be, for example, electronic, electromagnetic, optical, or other signals capable of being received by communications interface 1524. These signals are provided to communications interface 1524 via a communications path (i.e., channel) 1526. This channel 1526 carries signals and may be implemented using wire or cable, fiber optics, a phone line, a cellular phone link, an RF link, and/or other communications channels.

In this document, the terms “computer program medium,” “computer-usable medium,” “machine-readable medium” and “computer-readable medium” are used to generally refer to media such as main memory 1506 and secondary memory 1512, removable storage drive 1516, a hard disk installed in hard disk drive 1514, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as floppy, ROM, flash memory, disk drive memory, CD-ROM, and other permanent storage. It is useful, for example, for transporting information, such as data and computer instructions, between computer systems. Furthermore, the computer-readable medium may include computer-readable information in a transitory state medium such as a network link and/or a network interface, including a wired network or a wireless network, that allow a computer to read such computer-readable information.

Computer programs (also called computer control logic) are stored in main memory 1506 and/or secondary memory 1512. Computer programs may also be received via communications interface 1524. Such computer programs, when executed, enable the computer system to perform the features of the present invention as discussed herein. In particular, the computer programs, when executed, enable the processor 1504 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method on a wireless device comprising:
detecting a movement of a wireless device; and
in response to the detecting the movement, providing user input to a user interface of the wireless device.

2. The method of claim 1, wherein the movement comprises at least one of:
a gesture movement imparted by a user of the wireless device; and
a tilting of the wireless device.

3. The method of claim 1, wherein the wireless device is movably coupled to one of a wheelchair, a bed, and an automobile accessory, and wherein the detected movement comprises at least one of
a gesture movement imparted by a user of the one of the wheelchair, the bed, and the automobile accessory, and
a tilting of the wireless device while being movably coupled to the one of the wheelchair, the bed, and the automobile accessory.

4. The method of claim 1, wherein the wireless device is movably coupled to one of a wheelchair and a bed, and wherein the detected movement comprises a tilting of the wireless device while being movably coupled to the one of the wheelchair and the bed, and wherein the tilting represents an alarm condition of the one of the wheelchair and the bed, and in response to detecting the alarm condition, providing user input to a user interface of the wireless device thereby providing indication of the alarm condition to the wireless device.

5. The method of claim 4, wherein in response to providing indication of the alarm condition to the wireless device the wireless device wirelessly sending an alarm signal destined for reception by at least one other party other than the user of the wireless device.

6. The method of claim 5, wherein the at least one other party comprises at least one of an authority, such as a hospital or police, a caregiver, a friend, and a member of a family of the user of the one of the wheelchair and the bed.

7. The method of claim 1, wherein the detecting comprises:
detecting, by an accelerometer, a movement imparted to the wireless device by a user of the wireless device.

8. The method of claim 7, wherein the accelerometer is any one of:
integrally located in the wireless device; and
located externally to the wireless device and coupled to the wireless device.

9. The method of claim 1, wherein the detecting comprises:
detecting, by an accelerometer, a movement imparted to the wireless device by a user of the wireless device, the movement occurring along at least one axis.

10. The method of claim 1, wherein the user input comprises at least one of:
navigating selections in the user interface of the wireless device; and
activating selections in the user interface of the wireless device.

11. The method of claim 10, wherein the navigating selections comprises at least one of:
moving between pages displaying list of selections; and
scrolling through a list of selections.

12. The method of claim 10, wherein the activating selections comprises at least one of:
initiating a wireless telephone call;
answering a wireless telephone call;
sending a wireless message; and
receiving a wireless message.

13. A movement-based interface system, comprising:
a wireless device comprising a user interface;
a motion detector for detecting motion of the wireless device and imparted by a user;
a signal generator coupled to the motion detector for sending a signal to a processor when motion is detected by the motion detector; and
a processor in the wireless device for receiving the signal from the signal generator, processing the signal and, providing user input to the user interface of the wireless device.

14. The system of claim 13, further comprising a holder for movably coupling the wireless device to any one of:
a wheelchair;
a bed; and
an automobile accessory.

15. The system of claim 13, wherein the motion detector comprises:
an accelerometer for detecting motion of the wireless device imparted by a user.

16. The system of claim 13, wherein the motion detector is any one of:
integrally located in the wireless device; and
located externally to the wireless device and coupled to the wireless device.

17. The system of claim 13, wherein the motion detector comprises:
an accelerometer for detecting motion of the wireless device imparted by a user, the motion occurring along any of three axes.

18. The system of claim 13, wherein the user input comprises at least one of:
navigating selections in the user interface of the wireless device; and
activating selections in the user interface of the wireless device.

19. The system of claim 18, wherein the navigating selections comprises at least one of:
moving between pages displaying list of selections; and
scrolling through a list of selections.

20. The system of claim 18, wherein the activating selections comprises at least one of:
initiating a wireless telephone call;
answering a wireless telephone call;
sending a wireless message; and
receiving a wireless message.

21. A computer program product including computer instructions for operating in a wireless device, the computer instructions including instructions for:
detecting a movement of a wireless device; and
in response to the detecting the movement, providing user input to a user interface of the wireless device.

22. The computer program product of claim 21, wherein the instructions for detecting comprise instructions for:
detecting, by an accelerometer, a movement imparted to the wireless device by a user of the wireless device.

23. The computer program product of claim 22, wherein the accelerometer is any one of:
integrally located in the wireless device; and
located externally to the wireless device and coupled to the wireless device.

24. The computer program product of claim 21, wherein the instructions for detecting comprise instructions for:
detecting, by an accelerometer, a movement imparted to the wireless device by a user of the wireless device, the movement occurring along at least one axis.

25. The computer program product of claim 21, wherein the user input comprises at least one of:
navigating selections in the user interface of the wireless device; and
activating selections in the user interface of the wireless device.
